(19) United States
(12) Patent Application Publication
(10) Pub. No.: US 2018/0083382 A1
(43) Pub. Date: Mar. 22, 2018

(54) An adapter

(71) Applicant: Shenzhen SOY Technology Co.,Ltd., Guangdong (CN)

(72) Inventor: Shao Peng LI, Guangdong (CN)

(21) Appl. No.: 15/526,341

(22) PCT Filed: Feb. 24, 2016
(86) PCT No.: PCT/CN2016/074391

§ 371 Date: May 12, 2017

(30) Foreign Application Priority Data
Feb. 2, 2016 (CN) 201620103285.6

(51) Int. Cl. H01R 13/502; H01R 13/66; H01R 13/527

(52) U.S. Cl. CPC H01R 13/502; H01R 13/527; H01R 13/6658

(57) ABSTRACT

An adapter having a middle shell; a plug shell and an upper shell are provided respectively at a front end and a rear end of the middle shell; a rear end of the upper shell is provided with a wire; a rear end of the wire is connected with a plug element; a left side of the middle shell is provided with insulating plate; a left side of the insulating plate is provided with cooling fins; a right side of the middle shell is provided with a printed circuit board assembly (PCBA). The middle shell, the upper shell and the plug shell are all made of PC fireproof materials. The wire is made of PVC fireproof materials. The cooling fins are made of brass. The insulating plate is a PC insulating plate. The PCBA is made of glass fiber. The plug element is made of stainless steel.

### BACKGROUND OF THE INVENTION

The present invention relates to the technical field of adapter, and more specifically relates to a small sized adapter.

A currently available adapter for a laptop computer is too large that not portable. The large adapter adds too much weight to the laptop computer and therefore has to be reduced in size. Imported small sized adapters cannot meet the local safety requirements and thus cannot obtain local certifications, and also, they cannot achieve full-load power output and thus causes power loss. In view of the above problems, a small sized adapter is developed which can meet the standard local safety requirements and obtain local certifications, and can also satisfy the requirements for electrical performance.

### BRIEF SUMMARY OF THE INVENTION

The present invention provides a small size adapter to improve the effect of the use of the adapter, to provide better use effect of the adapter, and to facilitate its use according to practical need.

The present invention has adopted the following technical solutions:

A small sized adapter, comprising a middle shell; a plug shell is provided at a front end of the middle shell; an upper shell is provided at a rear end of the middle shell; a rear end of the upper shell is provided with a wire; a rear end of the wire is connected with a plug element; a left side of the middle shell is provided with insulating plate; a left side of the insulating plate is provided with cooling fins; a right side of the middle shell is provided with a printed circuit board assembly (PCBA).

Further, the middle shell, the upper shell and the plug shell are all made of PC fireproof materials.

Further, the wire is made of PVC fireproof materials

Further, the cooling fins are made of brass.

Further, the insulating plate is a PC insulating plate.

Further, the PCBA is made of glass fiber.

Further, the plug element is made of stainless steel.

The present invention has the following beneficial advantages: The present invention has a simple structure and a reasonable arrangement. The present invention can be easily assembled and has a small size. It is also portable and achieves good effect during use.

### BRIEF DESCRIPTION OF THE DRAWINGS

FIG. 1 is an exploded structural view according to an embodiment of the present invention.

References in the figures: 1: cooling fins; 2: insulating plate; 3: middle shell; 4: plug shell; 5: PCBA; 6: upper shell; 7: wire; 8: plug element

### DETAILED DESCRIPTION OF THE INVENTION

In order to facilitate better understanding of the present invention, an embodiment of the present invention will be described in detail below with reference to the accompanying drawings.

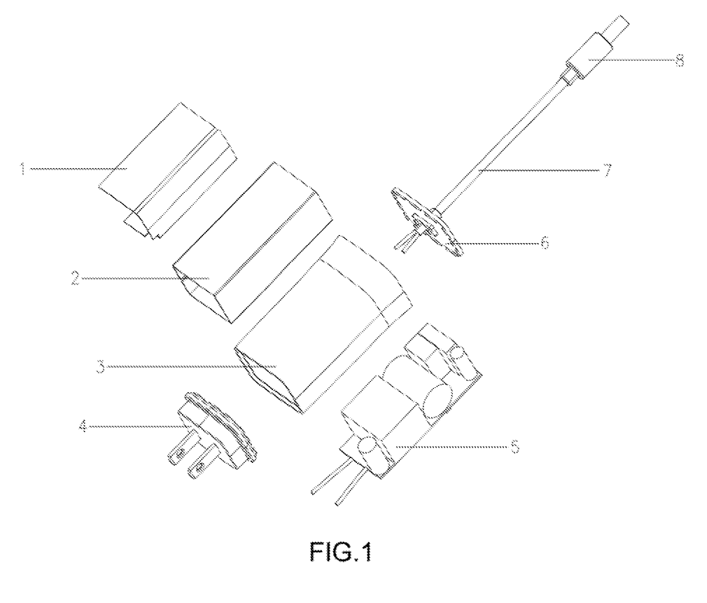

As shown in FIG. 1, a small sized adapter comprises a middle shell plug she 14 is provided at a front end of the middle shell 3; an upper shell 6 is provided at a rear end of the middle shell 3; a rear end of the upper shell 6 is provided with a wire 7; a rear end of the wire 7 is connected with a plug element 8; a left side of the middle shell 3 is provided with insulating plate 2; a left side of the insulating plate 2 is provided with cooling fins 1; a right side of the middle shell 3 is provided with a printed circuit board assembly (PCBA) 5.

According to a detailed embodiment, the middle shell 3, the upper shell 6 and the plug shell 4 are all made of PC fireproof materials. The wire is made of PVC fireproof materials. These materials are resistant to heat and high temperature and they are flame retardant. The cooling fins 1 are made of brass. The insulating plate 2 is a PC insulating plate; the PCBA 5 is made of glass fiber. The plug element 8 is made of stainless steel. Components on the PCBA 5 have small sizes and are custom made so that they can be skillfully arranged to form an assembly with densely packed components. The cooling fins 1, the insulting plate 2 and the PCBA 5 are integrated to reduce occupation of space.

The above description describes a preferred embodiment of the present invention. It should be pointed out that, improvements and modifications can be made by a person skilled in this field of art without deviating from the principle taught by the present invention, and all the improvements and modifications should also fall within the scope of protection of the present invention.

What is claimed is:

1. An adapter, comprising a middle shell; wherein a plug shell is provided at a front end of the middle shell; an upper shell is provided at a rear end of the middle shell; a rear end of the upper shell is provided with a wire; a rear end of the wire is connected with a plug element; a left side of the middle shell is provided with insulating plate; a left side of the insulating plate is provided with cooling fins; a right side of the middle shell is provided with a printed circuit board assembly (PCBA).

2. The adapter according to claim 1, wherein the middle shell, the upper shell and the plug shell are all made of PC fireproof materials.

3. The adapter according to claim 1, wherein the wire is made of PVC fireproof materials.

4. The adapter according to claim 1, wherein the cooling fins are made of brass.

5. The adapter according to claim 1, wherein the insulating plate is a PC insulating plate.

6. The adapter according to claim 1, wherein the PCBA is made of glass fiber.

7. The adapter according to claim 1, wherein the plug element is made of stainless steel.
